(19) United States
(12) Patent Application Publication
(10) Pub. No.: US 2007/0085322 A1
(43) Pub. Date: Apr. 19, 2007

(54) Book fabricated with different materials

(76) Inventor: Kuang-Ping Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/221,726

(22) Filed: Sep. 9, 2005

(51) Int. Cl. B42D 1/00

(52) U.S. Cl. 281/15.1

(57) ABSTRACT

The present invention discloses a book fabricated with different materials. The provided book comprises a plurality of first pages that consist of a first material and at least one second page that consists of a second material, wherein the plurality of first pages are fused and connected to each other through at least one hole on the at least one second page. In the meanwhile, the plurality of first pages and at least one second page are bound together and thus forms the provided book.

### BACKGROUND OF THE INVENTION

1. Field of the Invention

The present invention generally relates to the books, and more particularly to the books fabricated with different materials.

2. Description of the Prior Art

The materials used for book binding comprising not only papers, but also ethylene-vinylacetate copolymer (EVA), polyvinyl chloride(PVC), polyurethane (PU), polyethylene (PE), polypropene(PP), poly(ethylene terephthalate) (PET), polyester, and so on. Besides some simple binding manners, such as glue binding, sew binding, and flat stitching, the plastic materials can be bound by melting. It is often the high frequency melting or ultrasound melting, whereby the polar molecules repeatedly twist to generate heat for instantly melting and interflowing the plastic materials. But such a melting manner only can be used for binding the same materials, because different materials which have different melting points suit different frequencies. Nowadays different materials can barely use the glue binding or sew binding to resolve the problem for binding different materials. But if the book is a children's book or a baby's book which can be used in bath with some portion for water proof, the forgoing glue binding or sew binding will not work.

Accordingly, a demand of a new manner for binding different materials in book binding to satisfy the specific usage, low cost is indeed.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention provides a book fabricated with different materials fore reducing manufacture procedure, instantly producing, and achieving benefits.

On objective of the present invention is to form gaps for binding by making holes, whereby different materials can be bound by melting. The materials can be ethylene-vinylacetate copolymer (EVA), polyvinyl chloride(PVC), polyurethane (PU), polyethylene (PE), polypropene (PP), poly(ethylene terephthalate) (PET), polyester, synthetic paper, wood pulp paper, cloth and leather. The melting manner can further comprises a high frequency melting or an ultrasound melting. Moreover, most of the synthetic papers use the resin to be their main material and they also contains some other inorganic mine powders or organic materials. Therefore plastic materials and synthetic paper can be bound by melting. However, the wood pulp paper, cloth, wood slice, and leather would not suit to being bound by melting. Thus by punching holds on the wood pulp paper, cloth, wood slice, and leather and melting the plastic materials or synthetic papers for binding via the holds. Of course, the present invention also can be used for the binding of different materials.

Another objective of the present invention is to disclose how to make the water proof or easily dried book, i.e. the children books, baby books which can be used in the bath and so on. The prior art needs the whole book formed by the same water proof material and the cost of the printing is very expensive. The present can bind different materials by melting. For examples, the cheap materials can be punched holes and color printed for binding other materials which do not suit to color printing by melting. Furthermore, the present invention is compatible with the procedure of the present going book manufacture and no more equipment is needed. Accordingly, the present can reduce the cost, increase the multiplicity of printing, and take advantage of the specific effects of different materials to match the utilization in industry.

Accordingly, the present invention discloses a book fabricated with different materials, which comprises a plurality of first inside pages with a first material and at least one second inside page with a second material, wherein the plurality of first pages can be melted to bind to each other via the gaps that is formed by the holes in the second page. Therefore, the first pages and the second page can be bound to form a book fabricated with different materials.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates that the binding the melting are used in the same material according to the first embodiment of the present invention;

FIG. 2 is a diagram illustrates that the binding the melting are used in different materials according to the first embodiment of the present invention;

FIG. 3 is a diagram shows a book with two materials according to the second embodiment in the present invention;

FIG. 4 is a diagram shows a book with three materials according to the third embodiment in the present invention;

FIG. 5A is a diagram illustrates the binding and the melting of two materials according to the fourth embodiment in the present invention; and

FIG. 5B is a diagram illustrates the binding and the melting of two materials according to the fourth embodiment in the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

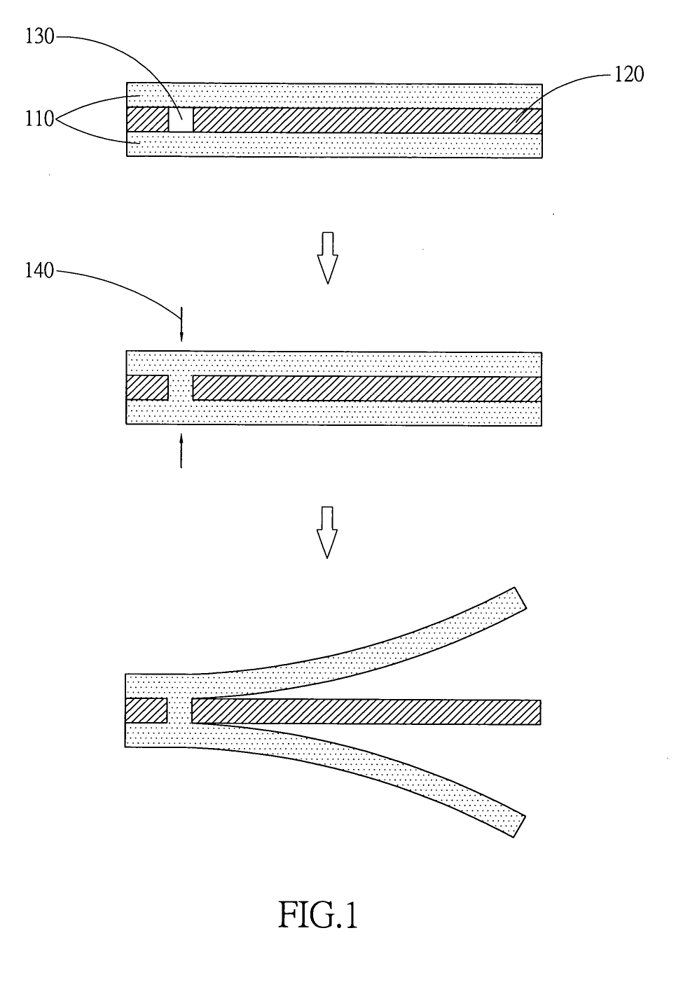

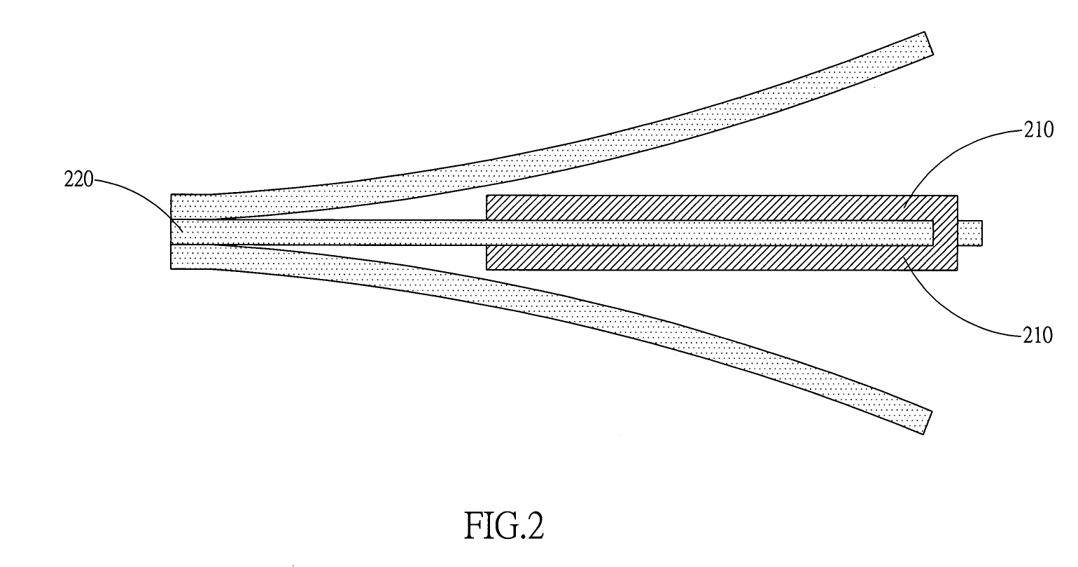

Referring to FIG. 1 and FIG. 2, the first embodiment of the present invention discloses a book fabricated with different materials, comprising a plurality of first inside pages (110, 210) with a first material and at least a second inside page (120, 220) with a second material, wherein the plurality of first inside page are the main portion for binding. Related to the materials of the insides pages, the first material is different from the second material. The first material can be a set selected from the following group: ethylene-vinylacetate copolymer (EVA), polyvinyl chloride(PVC), polyurethane (PU), polyethylene (PE), polypropene(PP), poly(ethylene terephthalate) (PET), polyester, and synthetic paper. The second material can be selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather. Furthermore, at least one second inside page (120, 220) is between first inside pages (110, 210). A plurality of first inside pages can be melted to bind with the second page via at least one hole gap 130 of the second page. The melting manner can further comprises a high frequency melting or a ultrasound melting 140 for binding a plurality of first inside page (110, 210) and at least one second inside page (120, 220), whereby a book fabricated with different materials can be made.

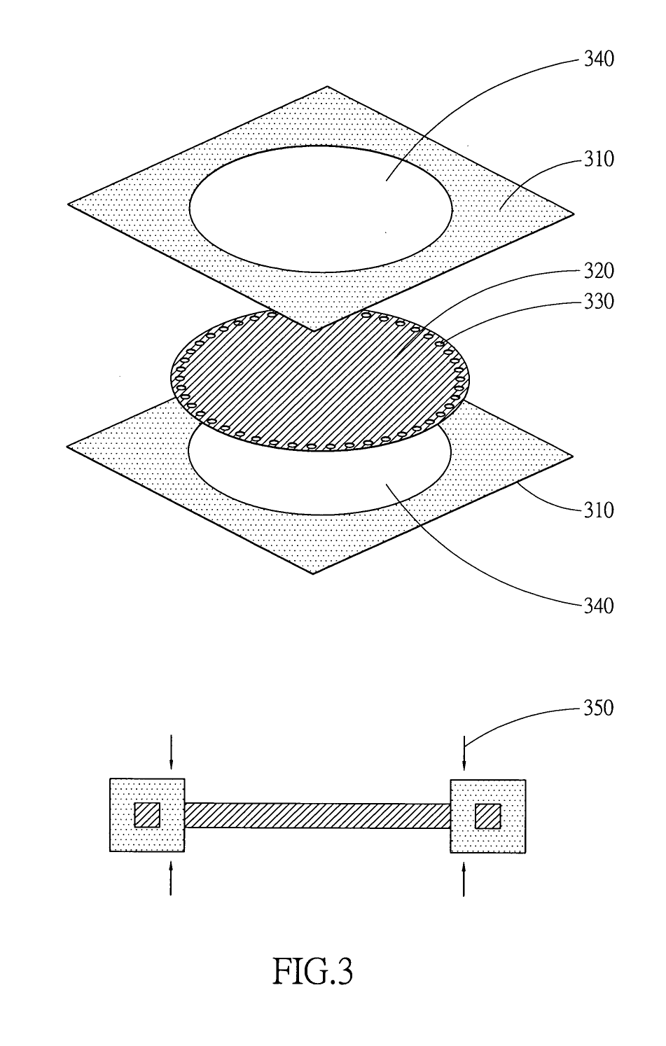

Referring to FIG. 3, the second embodiment of the present invention discloses a book fabricated with different materials, comprising two first inside page 310 with a first material and a second page 320 with a second material. Both of the two first inside pages have a hole gap 340 with a specific shape. The dimension of the second inside page 320 is a little larger than the hole gap 340. Besides, there are a plurality of holds around the edge of the second inside page 320. With regard to the materials of the inside pages, the first material is different from the second material. The first material can be a set selected from the following group: ethylene-vinylacetate copolymer (EVA), polyvinyl chloride(PVC), polyurethane (PU), polyethylene (PE), polypropene(PP), poly(ethylene terephthalate) (PET), polyester, and synthetic paper. The second material can be selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather. Furthermore, the two first inside pages 310 alias to each other according to the hold gaps 340. The second inside page 320 is between the two first inside pages 310 and aligns the hole gaps 340. The holes 330 must be averted from the hole gap 340. The two first inside pages 310 can be bound to each other via the holes 330 by melting. The melting manner can further comprises a high frequency melting or a ultrasound melting 350 for binding a plurality of first inside page 310 and at least one second inside page 320, whereby a book fabricated with different materials can be made.

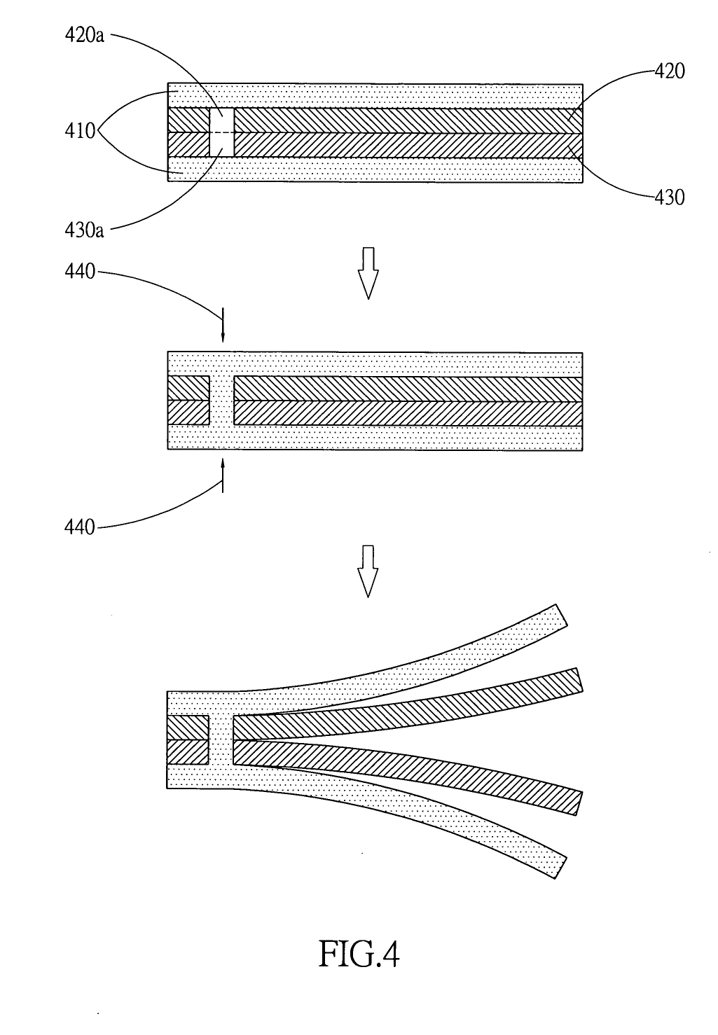

Referring to FIG. 4, the third embodiment of the present invention discloses a book fabricated with different materials, comprising a plurality of first inside pages 410 with a first material, a second inside page 420 with a second material, and a third inside page 430 with a third material, wherein the plurality of first inside page 410 is the main portion for binding. With regard to the materials of the inside pages, the first material is different from the second material and the third material. The first material can be a set selected from the following group: ethylene-vinylacetate copolymer (EVA), polyvinyl chloride(PVC), polyurethane (PU), polyethylene (PE), polypropene(PP), poly(ethylene terephthalate) (PET), polyester, and synthetic paper. The second material and the third material can be selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather. Furthermore, at least one second page 420 has at least one first hole 420a, and at least one third page 430 has at least second hole 430a. Each of said at least one first hole 420a one to one aligns a second hole 430a to form a gap for binding the plurality of first pages via the gap by melting. The melting manner can further comprises a high frequency melting or a ultrasound melting 440 for binding a plurality of first inside page 410, at least one second inside page 420, and at least third inside page 430, whereby a book fabricated with different materials can be made.

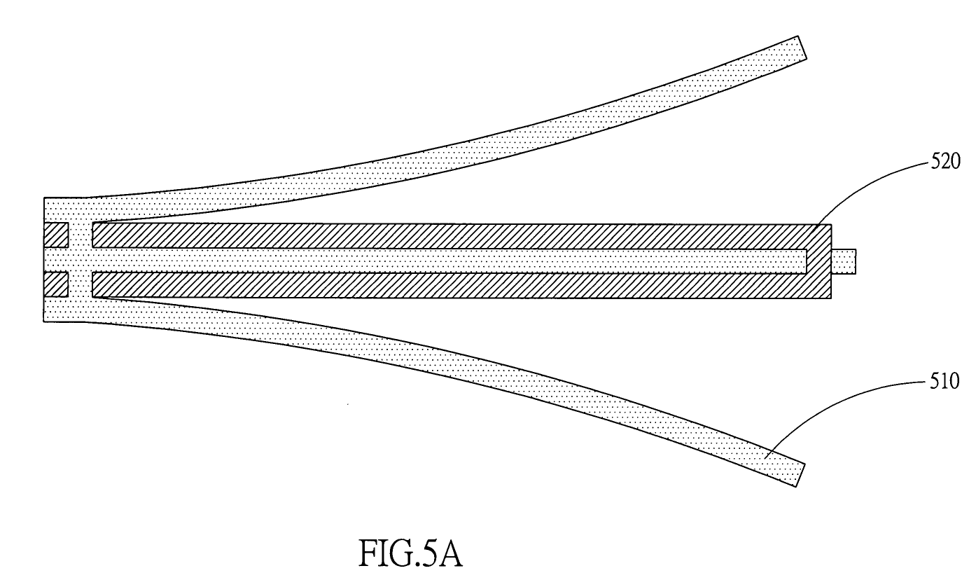

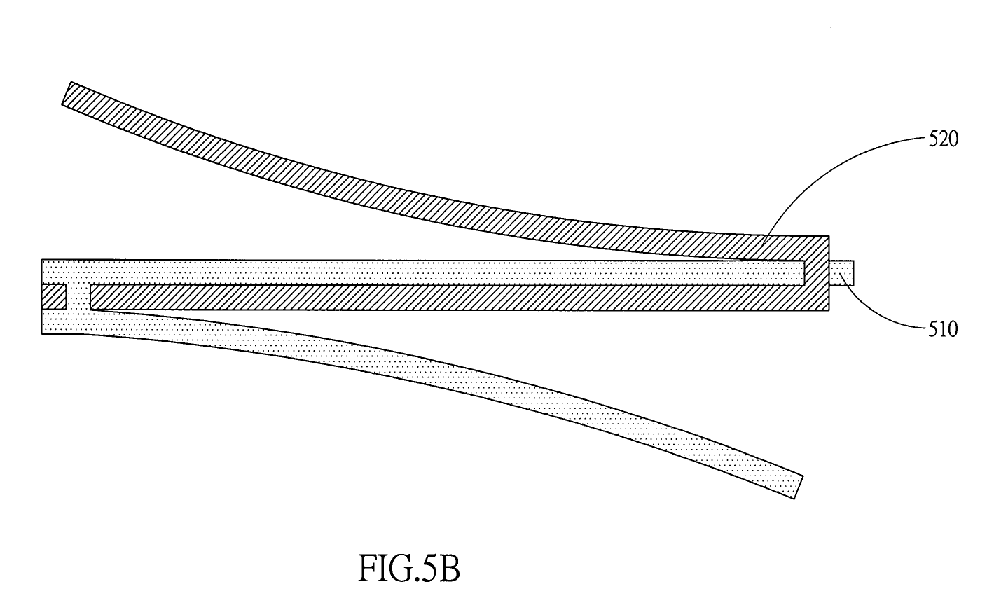

Referring to FIG. 5A and 5B, the fourth embodiments of the present invention discloses a book fabricated with different materials, comprising a plurality of first page 510 with a first material and a plurality of second page 520 with a second material. With regard to the materials of the inside pages, the first material is different from the second material. The first material can be a set selected from the following group: ethylene-vinylacetate copolymer (EVA), polyvinyl chloride(PVC), polyurethane (PU), polyethylene (PE), polypropene(PP), poly(ethylene terephthalate) (PET), polyester, and synthetic paper. The second material and the third material can be selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather. Furthermore, the plurality of first inside pages 410 have at least one first hole and the plurality of second inside pages 420 have at least one second hole. The first hole forms a first gap for binding the plurality of first pages 510 to each other via the first gap by melting, and the second hole forms a second gap for binding the plurality of second pages 520 to each other via the second gap by melting. Thus a book binding a plurality of first pages 510 and a plurality of second pages 520 can be made. The melting manner can further comprises a high frequency melting or an ultrasound melting.

In the above described embodiments of the present invention, the present invention discloses the gaps formed by the punched holes for binding different materials via the gaps by melting. For examples, the materials can be ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather. The melting manner can further comprises a high frequency melting or an ultrasound melting. Moreover, most of the synthetic papers use the resin to be their main material and they also contains some other inorganic mine powders or organic materials. Therefore plastic materials and synthetic paper can be bound by melting. However, the wood pulp paper, cloth, wood slice, and leather would not suit to being bound by melting. Thus by punching holds on the wood pulp paper, cloth, wood slice, and leather and melting the plastic materials or synthetic papers for binding via the holds. Of course, the present invention also can be used for the binding of different materials.

Afterwards, the present invention also disclose how to make the water proof or easily dried book, i.e. the children books, baby books which can be used in the bath and so on. The prior art needs the whole book formed by the same water proof material and the cost of the printing is very expensive. The present can bind different materials by melting. For examples, the cheap materials can be punched holes and color printed for binding other materials which do not suit to color printing by melting. Furthermore, the present invention is compatible with the procedure of the present going book manufacture and no more equipment is needed. Accordingly, the present can reduce the cost, increase the multiplicity of printing, and take advantage of the specific effects of different materials to match the utilization in industry.

Accordingly, the present invention discloses a book fabricated with different materials, which comprises a plurality of first inside pages with a first material and at least one second inside page with a second material, wherein the plurality of first pages can be melted to bind to each other via the gaps that is formed by the holes in the second page. Therefore, the first pages and the second page can be bound to form a book fabricated with different materials.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A book fabricated with different materials, comprising:
a plurality of first pages with a first material, wherein said first pages are the main portion for binding;
at least a second page with a second material between said first pages, wherein said second page has a gap which is formed by at least a hole and the first pages can be melted to bind together via said gap, whereby said first pages and said second page can be bound to form said book fabricated with different materials.

2. A book fabricated with different materials of claim 1, wherein said first material and said second material are different.

3. A book fabricated with different materials of claim 1, wherein said first material is selected from the following group: ethylene-vinylacetate copolymer (EVA), polyvinyl chloride(PVC), polyurethane (PU), polyethylene (PE), polypropene(PP), poly(ethylene terephthalate) (PET), polyester, and synthetic paper.

4. A book fabricated with different materials of claim 1, wherein said second material is selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather.

5. A book fabricated with different materials of claim 1, wherein said melting is a high frequency melting.

6. A book fabricated with different materials of claim 1, wherein said melting is a ultrasound melting.

7. A book fabricated with different materials, comprising:
a plurality of first pages with a first material, wherein said first pages are the main portion for binding;
at least a second page with a second material, wherein said at least a second page further comprises at least a first hole;
at least a third page with a third material, wherein said at least a third page further comprises at least a second hole, wherein said at least a first hole aligns said at least a second hole to form at least a gap and said first pages can be melted to bind together via said gap, whereby said first pages, said second page, and said third page can be bound to form said book fabricated with different materials.

8. A book fabricated with different materials of claim 7, wherein said first material and said second material are different and said first material and said third material are different.

9. A book fabricated with different materials of claim 7, wherein said first material is selected from the following group: ethylene-vinylacetate copolymer (EVA), polyvinyl chloride(PVC), polyurethane (PU), polyethylene (PE), polypropene(PP), poly(ethylene terephthalate) (PET), polyester, and synthetic paper.

10. A book fabricated with different materials of claim 7, wherein said second material and said third material are selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather.

11. A book fabricated with different materials of claim 7, wherein said melting is a high frequency melting.

12. A book fabricated with different materials of claim 7, wherein said melting is a ultrasound melting.

13. A book fabricated with different materials, comprising:
a plurality of first pages with a first material, wherein said first pages comprise at least a first hole to form a first gap;
a plurality of second pages with a second material, wherein said second pages have at least a second hole to form a second gap, wherein said second pages can be melted to bind together via said at least a first gap and said first pages can be melted to bind together via said at least a second gap to form a book fabricated with different materials.

14. A book fabricated with different materials of claim 13, wherein said first material and said second material are different.

15. A book fabricated with different materials of claim 13, wherein said first material and said second material are selected from the following group: ethylene-vinylacetate copolymer (EVA), polyvinyl chloride(PVC), polyurethane (PU), polyethylene (PE), polypropene(PP), poly(ethylene terephthalate) (PET), polyester, synthetic paper, wood pulp paper, cloth and leather.

16. A book fabricated with different materials of claim 13, wherein said melting is a high frequency melting.

17. A book fabricated with different materials of claim 13, wherein said melting is a ultrasound melting.
